(19) United States
(12) Patent Application Publication
(10) Pub. No.: US 2026/0343398 A1
(43) Pub. Date: Oct. 29, 2026

(54) NETWORK CONTROLLED REPEATER, RADIO ACCESS NETWORK NODE, AND METHODS THEREFOR

(71) Applicant: NEC Corporation, Minato-ku, Tokyo (JP)

(72) Inventors: Satoaki HAYASHI, Tokyo (JP); Yuhua CHEN, London (GB)

(73) Assignee: NEC Corporation, Minato-ku, Tokyo (JP)

(21) Appl. No.: 19/107,176

(22) PCT Filed: Jul. 6, 2023
(86) PCT No.: PCT/JP2023/025080

§ 371 Date: Feb. 27, 2025

(30) Foreign Application Priority Data
Sep. 28, 2022 (JP) 2022-155435

(51) Int. Cl. H04W 48/20; H04W 16/26

(52) U.S. Cl. CPC H04W 48/20; H04W 16/26

(57) ABSTRACT

A Network Controlled Repeater (NCR) (1) includes a repeater unit (11) and a controller (12). The repeater unit (11) is equipped with a radio frequency (RF) component and is configured to amplify and forward RF signals. The controller (12) is coupled to the repeater unit (11) and configured to provide NCR mobile termination (MT). The controller (12) is configured to use an NCR-MT-specific second minimum required received power or minimum required quality level in a cell, which is different from a first minimum required received power or minimum required quality level in the cell for a normal User Equipment (UE) that is not an NCR-MT, to determine whether the cell meets a cell selection criterion. This may help, for example, to regulate access to a cell by a controller of an NCR.

### TECHNICAL FIELD

The present disclosure relates to a radio communication system, and in particular to a network controlled repeater (NCR).

### BACKGROUND ART

For 3rd Generation Partnership Project (3GPP (registered trademark)) Release 18, the 3GPP is discussing about a Network Control Repeater (NCR) (see, for example, non-patent literature 1-6). An NCR is a Radio Frequency (RF) repeater that has been extended to have the functionality to receive and process side control information from the network. An RF repeater is a type of network node that simply amplifies and retransmits its received signals. An NCR may also be referred to as a smart repeater.

An NCR has both NCR-Forwarding (NCR-Fwd) and NCR-Mobile termination (NCR-MT) functions. The NCR-Fwd may also be referred to as an NCR Repeater Unit (NCR-RU) or NCR Radio Unit (NCR-RU). The NCR-MT may also be referred to as an NCR-Mobile terminal, controller, or NCR controller. The NCR-Fwd is defined as a functional entity that performs amplification and forwarding of uplink (UL) and downlink (DL) RF signals between a gNB and a User Equipment (UE) via a backhaul link and an access link. The NCR-MT is defined as a functional entity that communicates with the gNB via the control link to enable the exchange of control information (e.g., at least the side control information for controlling the NCR-Fwd). The operation of the NCR-Fwd is controlled according to the side control information received from the gNB.

### CITATION LIST

### Non Patent Literature

[Non-Patent Literature 1] ZTE Corporation, “New SI: Study on NR Network-controlled Repeaters”, RP-213700, 3GPP TSG RAN Meeting #94e, Dec. 6-17, 2021

[Non-Patent Literature 2] 3GPP TR 38.867 V1.0.0 (2022-09) “3rd Generation Partnership Project; Technical Specification Group Radio Access network; Study on NR network-controlled repeaters; (Release 18)”, September 2022

[Non-Patent Literature 3] Huawei, HiSilicon, “Discussions on side control information to enable NR network-controlled repeaters”, R1-2203133, 3GPP TSG RAN WG1 Meeting #109-e, May 9-20, 2022

[Non-Patent Literature 4] ZTE, “Discussion on side control information to enable NR network-controlled repeaters”, R1-2203237, 3GPP TSG RAN WG1 Meeting #109-e, May 9-20, 2022

[Non-Patent Literature 5] Vivo, “Discussion on side control information to enable NR network-controlled repeaters”, R1-2203578, 3GPP TSG RAN WG1 Meeting #109-e, May 9-20, 2022

[Non-Patent Literature 6] Samsung, “Side control information to enable NR network-controlled repeaters”, R1-2203921, 3GPP TSG RAN WG1 Meeting #109-e, May 9-20, 2022

### SUMMARY OF INVENTION

### Technical Problem

The inventors have studied about an NCR and identified various problems. One of these problems relates to regulating an NCR-MT's access to a cell. Non-Patent Literature 1-6 does not disclose a method for regulating an NCR-MT's access to a cell.

One of the objects to be achieved by the example embodiments disclosed herein is to provide apparatuses, methods, and programs that contribute to regulating access to a cell by a controller (e.g., NCR-MT) of a network controlled repeater. It should be noted that this object is only one of the objects to be achieved by the example embodiments disclosed herein. Other objects or problems and novel features will become apparent from the following description and the accompanying drawings.

### Solution to Problem

In a first aspect, an NCR includes a repeater unit and a controller. The repeater unit is equipped with an RF component and is configured to amplify and forward RF signals. The controller is coupled to the repeater unit and configured to provide NCR-MT. The controller is further configured to use an NCR-MT-specific second minimum required received power or minimum required quality level in a cell to determine whether the cell meets a cell selection criterion. The second minimum required received power or minimum required quality level is different from a first minimum required received power or minimum required quality level in the cell for a normal User Equipment (UE) that is not an NCR-MT.

In a second aspect, a method performed by an NCR includes using an NCR-MT-specific second minimum required received power or minimum required quality level in a cell to determine whether the cell meets a cell selection criterion. The second minimum required received power or minimum required quality level is different from a first minimum required received power or minimum required quality level in the cell for a normal User Equipment (UE) that is not an NCR-MT.

In a third aspect, a radio access network (RAN) node is configured to broadcast cell selection information in a cell. The cell selection information includes a first parameter and further includes a second parameter or a third parameter. The first parameter represents a first minimum required received power or minimum required quality level in the cell used for cell selection by a normal UE that is not an NCR-MT. The second parameter represents a second minimum required received power or minimum required quality level in the cell used for cell selection by the NCR-MT. The third parameter is used by the NCR-MT to derive the second minimum required received power or minimum required quality level from the first parameter.

In a fourth aspect, a method performed by a RAN node includes broadcasting cell selection information in a cell. The cell selection information includes a first parameter and further includes a second parameter or a third parameter. The first parameter represents a first minimum required received power or minimum required quality level in the cell used for cell selection by a normal UE that is not an NCR-MT. The second parameter represents a second minimum required received power or minimum required quality level in the cell used for cell selection by the NCR-MT. The third parameter is used by the NCR-MT to derive the second minimum required received power or minimum required quality level from the first parameter.

In a fifth aspect, an NCR includes a repeater unit and a controller. The repeater unit is equipped with an RF component and is configured to amplify and forward RF signals between a RAN node and UEs. The controller is coupled to the repeater unit and configured to communicate with the RAN node via a control link to exchange control information. The controller is configured to receive a Radio Resource Control (RRC) release message from the RAN node requesting release of an RRC connection and indicating an access restriction period. The controller is further configured to refrain from initiating a random access procedure to the cell until at least the access restriction period has elapsed if a received power or received quality level in the cell is lower than a threshold value.

In a sixth aspect, a method performed by an NCR includes the steps of:
(a) receiving an RRC release message from a RAN node requesting release of an RRC connection and indicating an access restriction period; and
(b) refraining from initiating a random access procedure to the cell until at least the access restriction period has elapsed if a received power or received quality level in the cell is lower than a threshold value.

In a seventh embodiment, a RAN node is configured to determine release of an RRC connection in a cell for an NCR in response to a decrease or insufficiency of a received power or received quality level in the cell, and to send an RRC release message indicating an access restriction period to the NCR. The RRC release message causes the NCR to refrain from initiating a random access procedure to the cell until at least the access restriction period has elapsed if a received power or received quality level in the cell is lower than a threshold value.

In an eighth aspect, a method performed by a RAN node includes: determining release of an RRC connection in a cell for an NCR in response to a decrease or insufficiency of a received power or received quality level in the cell; and sending an RRC release message indicating an access restriction period to the NCR. The RRC release message causes the NCR to refrain from initiating a random access procedure to the cell until at least the access restriction period has elapsed if a received power or received quality level in the cell is lower than a threshold value.

In a ninth aspect, an NCR includes a repeater unit and a controller. The repeater unit is equipped with an RF component and is configured to amplify and forward RF signals between a RAN node and UEs. The controller is coupled to the repeater unit and configured to communicate with the RAN node via a control link to exchange control information. The controller is configured to transmit an RRC setup or resume request message requesting an establishment or resumption of an RRC connection in a cell. The RRC setup or resume request message indicates a measurement result for the cell recorded while the NCR is RRC_IDLE or RRC_INACTIVE.

In a tenth aspect, a method performed by an NCR includes transmitting an RRC setup or resume request message requesting an establishment or resumption of an RRC connection in a cell. The RRC setup or resume request message indicates a measurement result for the cell recorded while the NCR is RRC_IDLE or RRC_INACTIVE.

In an eleventh aspect, a RAN node is configured to receive from an NCR an RRC setup or resume message requesting an establishment or resumption of an RRC connection in a cell. The RRC setup or resume request message indicates a measurement result for the cell recorded while the NCR is RRC_IDLE or RRC_INACTIVE.

In a twelfth aspect, a method performed by a RAN node includes receiving from an NCR an RRC setup or resume message requesting an establishment or resumption of an RRC connection in a cell. The RRC setup or resume request message indicates a measurement result for the cell recorded while the NCR is RRC_IDLE or RRC_INACTIVE.

In a thirteenth aspect, an NCR includes a repeater unit and a controller. The repeater unit is equipped with an RF component and is configured to amplify and forward RF signals between a RAN node and UEs. The controller is coupled to the repeater unit and configured to communicate with the RAN node via a control link to exchange control information. The controller is configured to transmit an RRC setup or resume complete message indicating completion of establishment or resumption of an RRC connection in a cell. The RRC setup or resume complete message indicates a measurement result for the cell recorded while the NCR is RRC_IDLE or RRC_INACTIVE.

In a fourteenth aspect, a method performed by an NCR includes transmitting an RRC setup or resume complete message indicating completion of establishment or resumption of an RRC connection in a cell. The RRC setup or resume complete message indicates a measurement result for the cell recorded while the NCR is RRC_IDLE or RRC_INACTIVE.

In a fifteenth aspect, a RAN node is configured to receive from an NCR an RRC setup or resume complete message indicating completion of establishment or resumption of an RRC connection in a cell. The RRC setup or resume complete message indicates a measurement result for the cell recorded while the NCR is RRC_IDLE or RRC_INACTIVE.

In a sixteenth aspect, a method performed by a RAN node includes receiving from an NCR an RRC setup or resume complete message indicating completion of establishment or resumption of an RRC connection in a cell. The RRC setup or resume complete message indicates a measurement result for the cell recorded while the NCR is RRC_IDLE or RRC_INACTIVE.

A seventeenth aspect is directed to a program. The program includes a set of instructions (software code) that, when read into a computer, causes the computer to perform the method according to the second, fourth, sixth, eighth, tenth, twelfth, fourteenth, or sixteenth aspect described above.

### Advantageous Effects of Invention

According to the aspects described above, it is possible to provide apparatuses, methods, and programs that contribute to regulating access to a cell by a controller (e.g., NCR-MT) of a network controlled repeater.

### BRIEF DESCRIPTION OF DRAWINGS

FIG. 1 shows an example configuration of a radio communication system in an example embodiment;

FIG. 2 shows an example configuration of an NCR in an example embodiment;

FIG. 3 is a diagram explaining an operation of an NCR in an example embodiment;

FIG. 4 is a flowchart showing an example of an operation of an NCR in an example embodiment;

FIG. 5 is a sequence diagram showing an example of operations of a gNB and an NCR in an example embodiment;

FIG. 6 is a sequence diagram showing an example of operations of a gNB and an NCR in an example embodiment;

FIG. 7 is a sequence diagram showing an example of operations of a gNB and an NCR in an example embodiment;

FIG. 8 is a sequence diagram showing an example of operations of a gNB and an NCR in an example embodiment;

FIG. 9 is a block diagram showing an example configuration of a gNB in an example embodiment; and

FIG. 10 is a diagram showing an example configuration of an NCR-MT or controller in an example embodiment.

### EXAMPLE EMBODIMENT

Specific example embodiments will be described hereinafter in detail with reference to the drawings. Identical or corresponding elements are designated by the same symbols throughout the drawings, and duplicate explanations are omitted where necessary for the sake of clarity.

The following example embodiments are described with respect to the 3GGP 5th generation mobile communication system (5G system) and its evolution. However, these example embodiments can also be applied to other radio communication systems using network controlled repeaters.

As used in this specification, “if” can be interpreted to mean “when”, “at or around the time”, “after”, “upon”, “in response to determining”, “in accordance with a determination”, or “in response to detecting”, depending on the context. These expressions can be interpreted to mean the same thing, depending on the context.

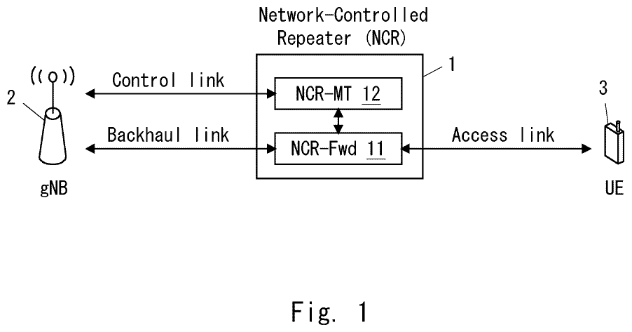

First, the configuration and operation of a plurality of network elements common to a plurality of example embodiments are described. FIG. 1 shows an example configuration of a radio communication system related to a plurality of example embodiments. Each of the elements shown in FIG. 1 is a network function that provides, for example, a 3GPP-defined interface. Each element (or network function) shown in FIG. 1 may be implemented, for example, as a network element on dedicated hardware, as a software instance running on dedicated hardware, or as a virtualized function instantiated on an application platform.

The network system shown in FIG. 1 includes an NCR 1, a gNB 2, and a UE 3. The gNB 2 may be referred to as a radio access network (RAN) node, base station, radio station, or access point. The UE 3 may be referred to by other terms such as radio terminal, mobile terminal, mobile station, or wireless transmit receive units (WTRUs). The gNB 2 may be a combination of a gNB-Central Unit (gNB-CU) and one or more gNB-Distributed Units (gNB-DUs) in a cloud RAN (C-RAN) deployment. C-RAN is also referred to as CU/DU split. In addition, a gNB-CU may include a Control Plane (CP) Unit (i.e., gNB-CU-CP) and one or more User Plane (UP) Units (i.e., gNB-CU-UPs).

The NCR 1 includes an NCR-Forwarding (NCR-Fwd) 11 and an NCR-Mobile termination (NCR-MT) 12. The NCR-Fwd 11 may also be referred to as an NCR Repeater Unit (NCR-RU) or NCR Radio Unit (NCR-RU). The NCR-MT 12 may be referred to as an NCR-Mobile terminal, controller, or NCR controller. The NCR-Fwd 11 is defined as a functional entity that performs amplification and forwarding of UL and DL RF signals between the gNB 2 and the UE 3 via a backhaul link and an access link. The NCR-MT 12 is defined as a functional entity that communicates with the gNB 2 via a control link to enable the exchange of control information (e.g., at least the side control information for controlling the NCR-Fwd 11). The operation of the NCR-Fwd 11 is controlled according to the side control information received from the gNB 2. The NCR-MT 12 may provide the side control information received from the gNB 2 to the NCR-Fwd 11. The NCR-MT 12 may control the operation of the NCR-Fwd 11 according to the side control information received from the gNB 2.

The control link between the NCR-MT 12 and the gNB 2 may reuse the legacy beam management mechanism. It is reasonable to assume that the control link does not have any heavy data transmission other than beam management reports. Accordingly, the NCR-MT 12 may not necessarily be a full-featured UE and may, for example, support the functionality defined for Reduced Capability (RedCap) UEs in 3GPP Release 17. A RedCap UE has reduced capabilities with the intention to have lower complexity with respect to non-RedCap UEs. It is mandatory for a RedCap UE to support 20 MHz maximum UE channel bandwidth in FR1 (i.e., sub-6 GHz band) and 100 MHz in FR2 (i.e., millimeter wave (mmWave) band). On the other hand, functions related to Carrier Aggregation (CA), Multi-Radio Dual Connectivity (MR-DC), Dual Active Protocol Stack (DAPS), and Integrated Access and Backhaul (IAB) are not supported by RedCap UEs. For RedCap UEs, the minimum number of UE Reception (Rx) branches and the maximum number of Downlink (DL) Multiple Input Multiple Output (MIMO) layers are reduced or relaxed compared to those for non-RedCap UEs.

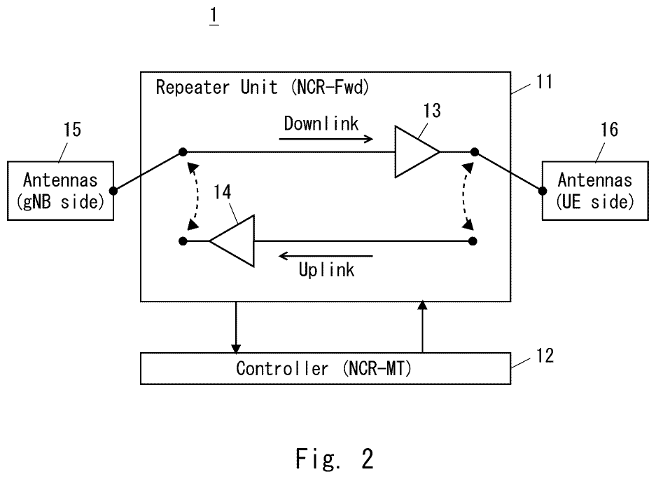

FIG. 2 shows an example configuration of the NCR 1. In the example shown in FIG. 2, the NCR-RU or NCR-Fwd 11 includes a downlink RF chain (or branch) with an amplifier 13 and an uplink RF chain (or branch) with an amplifier 14. The downlink RF chain may include other RF components. For example, the downlink RF chain may include one or more bandpass filters, a plurality of mixers (upconverters and downconverters), and one or more amplifiers. Similarly, the uplink RF chain may include other RF components, and may include one or more bandpass filters, a plurality of mixers (upconverters and downconverters), and one or more amplifiers. FIG. 2 shows an NCR for Time Division Duplex (TDD) mode. Accordingly, the connection to gNB-side antennas 15 and UE-side antennas 16 is switched between the downlink RF chain and the uplink RF chain according to the UL-DL TDD configuration. The NCR-Fwd 11 and the NCR-MT 12 share the gNB-side antennas 15 and part of the downlink and uplink RF chains.

### First Example Embodiment

This example embodiment provides details of cell selection performed by an NCR (or NCR-MT). In this example embodiment, to determine whether a cell of the gNB 2 meets a cell selection criterion, the NCR-MT 12 uses an NCR-MT-specific second minimum required received power or minimum required quality level in the cell, which differs from a first minimum required received power or minimum required quality level in the cell for a normal UE that is not an NCR-MT. The NCR-MT 12 may perform cell selection using both an NCR-MT-specific second minimum required received power level and an NCR-MT-specific second minimum required received quality level. The minimum required received power level in a cell defines the minimum required level of Reference Signal Received Power (RSRP) in the cell. The minimum required received quality level in a cell defines the minimum required level of Reference Signal Received Quality (RSRQ) in the cell. The RSRP may be Synchronization Signal (SS) RSRP. The RSRQ may be SS-RSRQ.

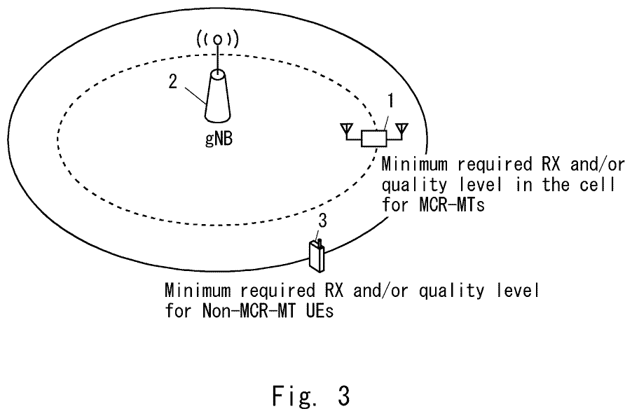

Network operators may have NCR-specific requirements for backhaul links to ensure the performance of NCR deployments. For example, NCRs can only be deployed in areas where the measured level is greater than the second minimum required received power or minimum required quality level specific to NCR-MTs. More specifically, as shown in FIG. 3, the second minimum required received power or minimum required quality level specific to NCR-MTs may be defined as being greater than the first minimum required received power or minimum required quality level for non-NCR-MT UEs (or normal UEs).

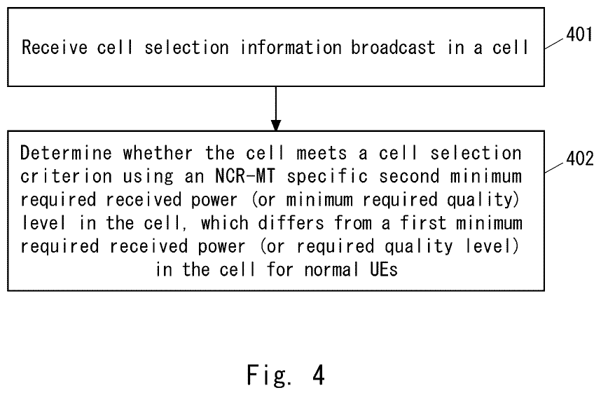

FIG. 4 shows an example of the operation of the NCR-MT 12. In step 401, the NCR-MT 12 receives cell selection information broadcast in a cell. In step 402, the NCR-MT 12 determines whether the cell meets a cell selection criterion using an NCR-MT specific second minimum required received power (or minimum required quality) level in the cell, which differs from a first minimum required received power (or required quality level) in the cell for normal UEs. As mentioned above, the NCR-MT 12 may use both the NCR-MT-specific second minimum required received power level and the NCR-MT-specific second minimum required received quality level for cell selection.

The gNB 2 broadcasts the cell selection information in the cell. In a first implementation, the cell selection information may include a first parameter (e.g., q-RxLevMin, q-QualMin) representing the first minimum required received power or minimum required quality level and a second parameter (e.g., q-RxLevMin_NCR, q-QualMin_NCR) representing the second minimum required received power or minimum required quality level. In this case, the NCR-MT 12 uses the second minimum required received power or minimum required quality level indicated by the second parameter to determine whether or not the cell meets a cell selection criterion.

In a second implementation, the cell selection information includes a first parameter representing the first minimum required received power or minimum required quality level and a third parameter (e.g., an offset) for deriving the second minimum required received power or minimum required quality level from the first parameter. In this case, the NCR-MT 12 calculates the second minimum required received power or minimum required quality level using the first parameter and the third parameter. The NCR-MT 12 then uses the derived second minimum required received power or minimum required quality level to determine whether or not the cell meets a cell selection criterion.

In a third implementation, a third parameter is specified in the specification. In other words, the third parameter (e.g., offset) is preset in the NCR-MT 12. Accordingly, in the third implementation, the cell selection information includes the first parameter representing the first minimum required received power or minimum required quality level, but does not include either the second parameter or the third parameter. In this case, the NCR-MT 12 derives the second minimum required received power or minimum required quality level from the first parameter using the predefined third parameter (e.g., offset). The NCR-MT 12 then uses the derived second minimum required received power or minimum required quality level to determine whether or not the cell meets a cell selection criterion.

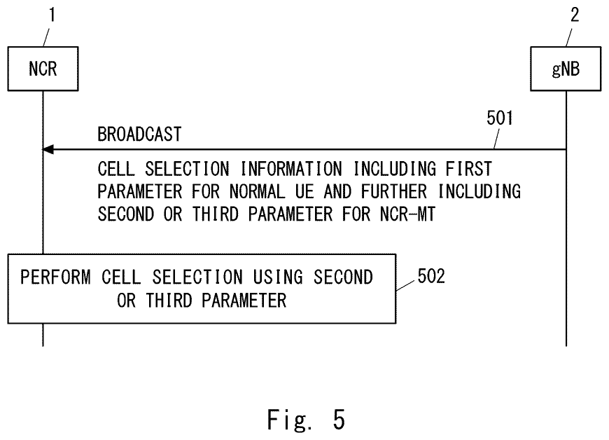

FIG. 5 shows an example of the operation of the NCR 1 and the gNB 2 in the first or second implementation described above. In step 501, the gNB 2 broadcasts cell selection information in the cell. This cell selection information includes the first parameter for non-NCR-MT UEs (normal UEs) and the second or third parameter for NCR-MTs. In step 503, the NCR 1 (NCR-MT 12) uses the second or third parameter to determine whether or not the cell satisfies a cell selection criterion.

The cell selection criterion for NCR-MTs may be the same as the existing cell selection criterion S in the 5G system. For example, the cell selection criterion for NCR-MTs is fulfilled when: Srxlev>0 AND Squal>0. Srxlev and Squal are as follows:

Srxlev=Qᵣₓₗₑᵥₘₑₐₛ−(Q_{rxlevmin_NCR}+Q_{rxlevminoffset})−P_{compensation}−Q_{offsettemp}, and

Squal=Q_{qualmeas}−(Q_{qualmin_NCR}+Q_{qualminoffset})−Q_{offsettemp}.

Q_{rxlevmin_NCR} is the second minimum required received power level for NCR-MTs. Q_{qualmin_NCR} is the second minimum required received quality level for NCR-MTs. Q_{rxlevminoffset} and Q_{qualminoffset} are offsets used to search for a higher priority PLMN while the UE camps on a Visited Public Land Mobile Network (VPLMN). Accordingly, in the cell selection criterion for NCR-MTs, Q_{rxlevminoffset} and Q_{qualminoffset} may be zero or may be omitted. For NCR-MTs, P_{compensation} may be zero. Qoffsettemp is an offset to be applied in the event of an RRC connection establishment failure, and is specified by the connEstFailOffset field in the ConnEstFailure Control information element in the System Information Block Type 1 (SIB1). If this field is not present in SIB1, an infinite value is applied to Qoffsettemp. The period during which Qoffsettemp is applied is specified by the connEstFailOffset Validity field in the ConnEstFailure Control information element.

Only one of Q_{rxlevmin_NCR} and Q_{qualmin_NCR} may be used. For example, Q_{rxlevmin_NCR} may be used and Q_{qualmin_NCR} may not be used. In this case, Q_{qualmin} for non-NCR-MT UEs (normal UEs) may be used instead of Q_{qualmin_NCR}.

According to the operation described in this example embodiment, the NCR-MT 12 can determine whether a cell satisfies a cell selection criterion using an NCR-MT-specific minimum required received power or minimum required quality level. This can help to regulate access to a cell by the NCR 1 (NCR-MT 12) using an NCR-MT-specific cell selection criterion different from that for normal UEs.

### Second Example Embodiment

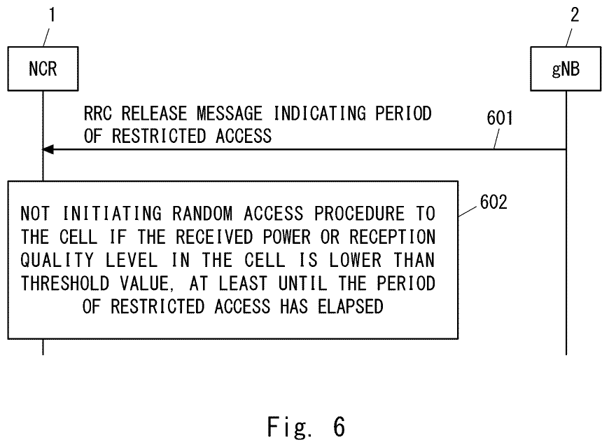

This example embodiment provides an improved RRC release procedure. FIG. 6 shows an example of the operation of the NCR 1 (NCR-MT 12) and the gNB 2. In step 601, the gNB 2 sends an RRC Release message indicating an access restriction period to the NCR 1 (NCR-MT 12). This RRC Release message requests the NCR 1 (NCR-MT 12) to release an RRC connection in a cell. In addition, this RRC Release message causes the NCR 1 (NCR-MT 12) to refrain from initiating a random access procedure to the cell until at least the access restriction period has elapsed if the received power (e.g., RSRP) or received quality (e.g., RSRQ) level in the cell is lower than a threshold value. The RRC Release message may also indicate the threshold value. The NCR 1 (NCR-MT 12) may perform threshold evaluation for both the received power (e.g., RSRP) level and the received quality (e.g., RSRQ) level. In this case, the RRC Release message may specify two threshold values, one for the received power (e.g., RSRP) level and one for the received quality (e.g., RSRQ) level.

In step 602, the NCR 1 (NCR-MT 12) releases the RRC connection in the cell. The NCR 1 (NCR-MT 12) then operates such that it does not initiate a random access procedure to the cell until at least the access restriction period has elapsed if the received power or received quality level in the cell is lower than the threshold value.

The access restriction period may be more than one hour. For example, the access restriction period may be one hour, two hours, four hours, eight hours, 16 hours, one day, three days, or seven days.

The gNB 2 may determine to release the RRC connection in the cell for the NCR 1 (NCR-MT 12) in response to a decrease or insufficiency in the received power or received quality level of the NCR 1 (NCR-MT 12). In this case, the RRC Release message in step 601 may indicate that the cause for releasing the RRC connection is a decrease or insufficiency in the received power or received quality level in the cell.

The gNB 2 may provide a measurement configuration to the NCR-MT 12 that is RRC_CONNECTED in the cell. The measurement configuration may include at least a measurement object for serving cell measurement and a reporting configuration associated with this measurement object. The reporting configuration may specify Event A2 (i.e., Serving becomes worse than threshold). Measured values for the serving cell may be RSRP, RSRQ, or Signal to Interference Noise Ratio (SINR). RSRP, RSRQ, and SINR may be SS-RSRP, SS-RSRQ, and SS-SINR. In this case, the gNB 2 may receive a measurement report triggered by Event A2 from the NCR-MT 12 and may decide to release the RRC connection of the NCR-MT 12 based on a measured value of the serving cell indicated by the measurement report.

Alternatively, the gNB 2 may send a Logged Measurement Configuration to the NCR-MT 12 that is RRC_CONNECTED in the cell. The Logged Measurement Configuration configures the NCR-MT 12 to perform logging of measurement results when it is in the RRC_IDLE or RRC IN ACTIVE state. The Logged Measurement Configuration may specify an Event L1 trigger, which is similar to Event A2 in the RRC_CONNECTED measurements. If the reportType field in the Logged Measurement Configuration is set to eventTriggered and the eventType field is set to eventL1, the NCR-MT 12 performs logging while the cell in which the NCR-MT 12 is camping in the normal camping state (i.e., the serving cell) satisfies event LI (i.e., Camping cell becomes worse than threshold). During logging, the NCR-MT 12 records measured values for the cell in which the NCR-MT 12 is camping. In this case, after the NCR-MT 12 has transitioned to RRC_CONNECTED, the gNB 2 may request the NCR-MT 12 to report information about logged measurements using a UE Information procedure. The gNB 2 may then decide to release the RRC connection of the NCR-MT 12 based on the measurement results of the serving cell recorded while the NCR-MT 12 was in RRC_IDLE or RRC_INACTIVE.

Alternatively, the gNB 2 may provide an Idle/inactive Measurement configuration to the NCR-MT 12 in an RRC Release message (sent before step 601, which is different from step 601) to transition the NCR-MT 12 from RRC_CONNECTED to RRC_IDLE or RRC_INACTIVE. The Idle/inactive Measurement configuration configures the NCR-MT 12 to measure the last serving cell (or the current camping cell in normal camping state) in the RRC_IDLE and RRC_INACTIVE states. When the NCR-MT 12 is in the RRC_IDLE or RRC_INACTIVE state, it records measured values for the cell (i.e., serving cell) in which it is camping. In this case, after the NCR-MT 12 has transitioned to RRC_CONNECTED, the gNB 2 may request the NCR-MT 12 to report information about Idle/inactive Measurements using a UE Information procedure. The gNB 2 may then decide to release the RRC connection of the NCR-MT 12 based on the measurement results of the serving cell recorded while the NCR-MT 12 was in RRC_IDLE or RRC_INACTIVE.

According to the operation described in this example embodiment, in a case where the gNB 2 releases the RRC connection of the NCR 1 whose control link quality is low (and thus the backhaul link quality is expected to be low), the gNB 2 can control the NCR 1 not to attempt cell access until the quality recovers or the access restriction period has expired. This can help to restrict access to a cell by the NCR 1 (NCR-MT 12) whose control link quality is low.

### Third Example Embodiment

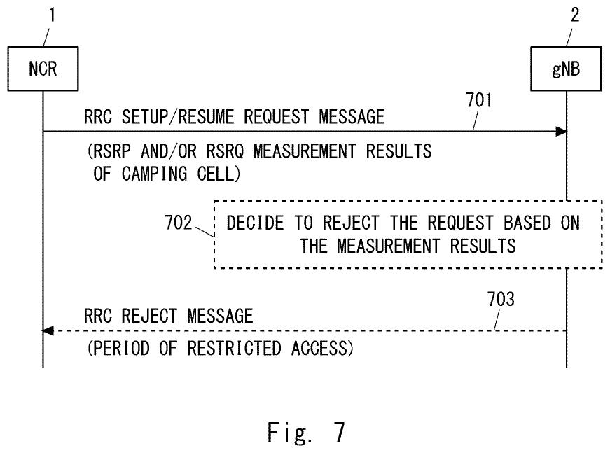

This example embodiment provides an improved RRC setup procedure. FIG. 7 shows an example of the operation of the NCR 1 (NCR-MT 12) and the gNB 2. In step 701, the NCR 1 (NCR-MT 12) transmits an RRC Setup Request message or an RRC Resume Request message. The RRC Setup Request message is sent by the NCR 1 (NCR-MT 12) in the RRC_IDLE state to request the establishment of an RRC connection in a cell. The RRC Resume Request Message is sent by the NCR 1 (NCR-MT 12) in the RRC_INACTIVE state to request the resumption of an RRC connection in a cell.

The RRC Setup or Resume Request message in step 701 indicates a measurement result for the cell (i.e., the cell where the NCR-MT 12 is camping or the serving cell) recorded while the NCR 1 (NCR-MT 12) was RRC_IDLE or RRC_INACTIVE. This measurement result of the cell indicates a measured value of the received power (e.g., RSRP) or quality (e.g., RSRQ, SINR) of the serving cell. This measurement result may be recorded based on a Logged Measurement Configuration or an Idle/inactive Measurement configuration. Logged measurements and idle/inactive measurements can be performed in a similar manner as those described in the second embodiment.

The RRC Setup or Resume Request message in step 701 can provide a measurement result of the serving cell (i.e., the cell in which the NCR-MT 12 is camping) to the gNB 2 faster than using the existing UE Information procedure. In one example, the gNB 2 can obtain the measurement result before establishing or resuming the RRC connection, and can decide whether to reject the RRC connection establishment or resumption based on the measurement result.

As an example, not as a limitation, the gNB 2 may perform steps 702 and 703. In step 702, the gNB 2 decides to reject the request message in step 701 based on the provided measurement results. In step 703, the gNB 2 sends an RRC Reject message to the NCR 1 (NCR-MT 12). The RRC Reject message may indicate that the reason for rejecting the establishment or resumption of the RRC connection is an insufficient received power or received quality level in the cell.

In addition or alternatively, the RRC Reject message may indicate an access restriction period. In this case, the RRC Reject message causes the NCR 1 (NCR-MT 12) to refrain from initiating a random access procedure to the cell until at least the access restriction period has elapsed if the received power (e.g., RSRP) or received quality (e.g., RSRQ) level in the cell is lower than a threshold value. The RRC Reject message may also indicate the threshold value. The NCR 1 (NCR-MT 12) may perform threshold evaluation for both the received power (e.g., RSRP) level and the received quality (e.g., RSRQ) level. In this case, the RRC Reject message may indicate two threshold values, one for the received power (e.g., RSRP) level and one for the received quality (e.g., RSRQ) level. The NCR 1 (NCR-MT 12) operates such that, if the received power or received quality level in the cell is lower than the threshold value, it does not initiate a random access procedure to the cell until at least the access restriction period has elapsed. The access restriction period may be more than one hour. For example, the access restriction period may be one hour, two hours, four hours, eight hours, 16 hours, one day, three days, or seven days.

According to the operation of steps 702 and 703, the gNB 2 can reject the establishment or resumption of an RRC connection of the NCR 1 with low control link quality (and thus, it is expected that the backhaul link quality will also be low), and can control the NCR 1 not to attempt cell access until the quality recovers or the access restriction period has expired. This can help to restrict access to a cell by the NCR 1 (NCR-MT 12) whose control link quality is low.

### Fourth Example Embodiment

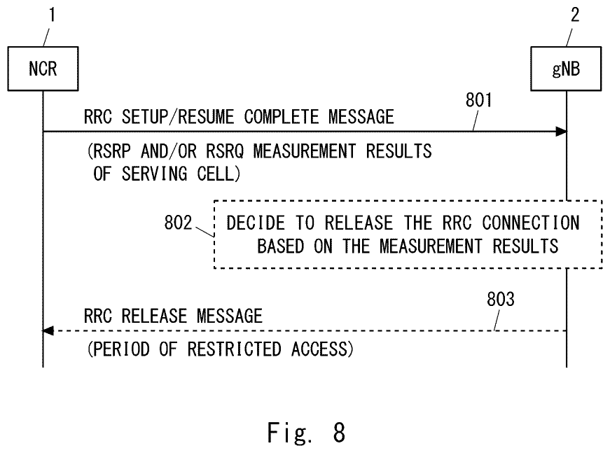

This example embodiment provides an improved RRC setup procedure. FIG. 8 shows an example of the operation of the NCR 1 (NCR-MT 12) and the gNB 2. In step 801, the NCR 1 (NCR-MT 12) sends an RRC Setup Complete message or an RRC Resume Complete message. The RRC Setup Complete message indicates that the NCR 1 (NCR-MT 12) has completed the establishment of an RRC connection. In other words, the RRC Setup Complete message is sent in a case where the NCR 1 (NCR-MT 12) has transitioned from RRC_IDLE or RRC_INACTIVE to RRC_CONNECTED. The RRC Resume Complete message indicates that the NCR 1 (NCR-MT 12) has completed the resumption of an RRC connection. In other words, the RRC Resume Complete message is sent in a case where the NCR 1 (NCR-MT 12) has transitioned from RRC_INACTIVE to RRC_CONNECTED.

The RRC Setup or Resume Complete message in step 801 indicates a measurement result for the cell (i.e., the cell where the NCR-MT 12 is camping or the serving cell of the NCR-MT 12) recorded while the NCR 1 (NCR-MT 12) was RRC_IDLE or RRC_INACTIVE. This measurement result of the cell indicates a measured value of the received power (e.g., RSRP) or quality (e.g., RSRQ, SINR) of the serving cell of the NCR-MT 12. This measurement result may be recorded based on a Logged Measurement Configuration or an Idle/inactive Measurement configuration. Logged measurements and idle/inactive measurements can be performed in a similar manner as those described in the second embodiment.

The RRC Setup or Resume Complete message in step 801 can provide a measurement result of the serving cell to the gNB 2 faster than using the existing UE Information procedure. In one example, the gNB 2 can obtain the measurement result immediately after the completion of the establishment or resumption of the RRC connection, and can decide whether or not to release the RRC connection based on the measurement result.

As an example, not as a limitation, the gNB 2 may perform steps 802 and 803. In step 802, the gNB 2 decides to release the RRC connection based on the provided measurement results. In step 803, the gNB 2 sends an RRC Release message to the NCR 1 (NCR-MT 12). The RRC Release message may indicate that the reason for rejecting the establishment or resumption of the RRC connection is an insufficient received power or received quality level in the cell.

In addition or alternatively, the RRC Release message may indicate an access restriction period. This RRC Release message may be similar to the RRC Release message described in the second example embodiment. Specifically, the RRC Release message causes the NCR 1 (NCR-MT 12) to refrain from initiating a random access procedure to the cell until at least the access restriction period has elapsed if the received power (e.g., RSRP) or received quality (e.g., RSRQ) level in the cell is lower than a threshold value. The RRC Release message may also indicate the threshold value. The NCR 1 (NCR-MT 12) may perform threshold evaluation for both the received power (e.g., RSRP) level and the received quality (e.g., RSRQ) level.

In this case, the RRC Release message may indicate two threshold values, one for the received power (e.g., RSRP) level and one for the received quality (e.g., RSRQ) level. The NCR 1 (NCR-MT 12) operates such that, if the received power or received quality level in the cell is lower than the threshold value, it does not initiate a random access procedure to the cell until at least the access restriction period has elapsed. The access restriction period may be more than one hour. For example, the access restriction period may be one hour, two hours, four hours, eight hours, 16 hours, one day, three days, or seven days.

According to the operation of steps 802 and 803, the gNB 2 can release an RRC connection of the NCR 1 with low control link quality (and thus, it is expected that the backhaul link quality will also be low), and can control the NCR 1 not to attempt cell access until the quality recovers or the access restriction period has expired. This can help to restrict access to a cell by the NCR 1 (NCR-MT 12) whose control link quality is low.

### Fifth Example Embodiment

This example embodiment is related to cell reselection. The NCR 11 is assumed to be a stationary type with no mobility. In addition, as mentioned above, the NCR-MT 12 may support the functionality defined for RedCap UEs. Accordingly, in this example embodiment, the NCR-MT 12 supports the same or similar functions as the relaxed measurement (or relaxed monitoring for cell reselection) defined for RedCap UEs in 3GPP Release 17.

More specifically, the NCR-MT 12 may support the same or similar functions as the relaxed measurement criterion for a stationary RedCap UE. The threshold value parameter S_{searchDeltaP-Stationary} for the relaxed measurement criterion for a stationary RedCap UE may be reused. Alternatively, a new threshold value parameter (e.g., S_{SearchDeltaP-Stationary2}) that differs from S_{SearchDeltaP-Stationary} may be defined.

Additionally or alternatively, the NCR-MT 12 may support the same or similar functions as the relaxed measurement criterion for a stationary RedCap UE not at cell edge. The threshold value parameter S_{SearchThresholdP2} for the relaxed measurement criterion for a stationary RedCap UE not at cell edge may be reused. Alternatively, a new threshold value parameter (e.g., S_{searchThresholdP3}) that differs from S_{SearchThresholdP2} may be defined.

### Other Example Embodiment

In some implementations, the NCR-MT 12 ignores cellBarred, cellReservedForOperatorUse, cellReservedForFutureUse, and intraFreqReselection in the same manner as the Integrated Access and Backhaul (IAB) MT. In other words, the NCR-MT 12 treats intraFreqReselection as if it were set to Allowed.

Additionally or alternatively, in some implementations, the NCR-MT 12 ignores cellReservedForOtherUse for cell barring determination. In other words, if the NCR-MT 12 supports Non-Public Network (NPN), the NCR-MT 12 considers cellReservedForOtherUse to determine NPN-only cells.

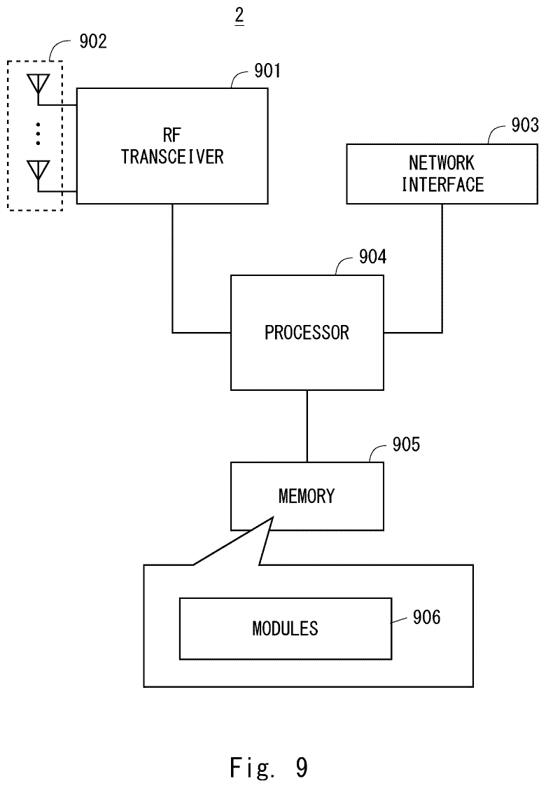

Examples of configurations of the gNB 2 and the NCR-MT 12 according to the plurality of example embodiments described above are provided below. FIG. 9 is a block diagram showing an example of the configuration of the gNB 2. Referring to FIG. 9, the gNB 2 includes a Radio Frequency (RF) transceiver 901, a network interface 903, a processor 904, and a memory 905. The RF transceiver 901 performs analog RF signal processing to communicate with UEs. The RF transceiver 901 may include a plurality of transceivers. The RF transceiver 901 is coupled to an antenna array 902 and the processor 904. The RF transceiver 901 receives modulated symbol data from the processor 904, generates a transmission RF signal, and supplies the transmission RF signal to the antenna array 902. The RF transceiver 901 generates a baseband reception signal based on a reception RF signal received by the antenna array 902 and supplies the baseband reception signal to the processor 904. The RF transceiver 901 may include an analog beamformer circuit for beamforming. The analog beamformer circuit includes, for example, a plurality of phase shifters and a plurality of power amplifiers.

The network interface 903 is used to communicate with network nodes (e.g., other RAN nodes, and control plane and user plane nodes in the core network). For example, the network interface 903 may include a network interface card (NIC) conforming to the IEEE 802.3 series.

The processor 904 performs digital baseband signal processing (data plane processing) and control plane processing for wireless communication. The processor 904 may include a plurality of processors. For example, the processor 904 may include a modem processor (e.g., Digital Signal Processor (DSP)) that performs digital baseband signal processing and a protocol stack processor (e.g., Central Processing Unit (CPU) or Micro Processing Unit (MPU)) that performs control plane processing.

For example, the digital baseband signal processing performed by the processor 904 may include signal processing for the Service Data Adaptation Protocol (SDAP), Packet Data Convergence Protocol (PDCP), Radio Link Control (RLC), Medium Access Control (MAC), and Physical (PHY) layers. The control plane processing performed by the processor 904 may also include processing of Non-Access Stratum (NAS) messages, RRC messages, Medium Access Control (MAC) Control Elements (CEs), and Downlink Control Information (DCI). The control plane processing performed by the processor 904 may also include processing of application layer signaling protocols such as XnAP, FIAP, and NGAP.

The processor 904 may include a digital beamformer module for beamforming. The digital beamformer module may include a Multiple Input Multiple Output (MIMO) encoder and precoder.

The memory 905 is composed of a combination of volatile and non-volatile memory. The volatile memory is, for example, Static Random Access Memory (SRAM), Dynamic RAM (DRAM), or a combination thereof. The non-volatile memory is Mask Read Only Memory (MROM), Electrically Erasable Programmable ROM (EEPROM), flash memory, hard disk drive, or any combination thereof. The memory 905 may include storage that is remote from the processor 904. In this case, the processor 904 may access the memory 905 through a network interface 903 or an I/O interface.

The memory 905 may store one or more software modules (or £ computer programs) 906 containing a set of instructions and data for processing by the gNB 2 described in the example embodiments described above. In some implementations, the processor 904 may be configured to read and execute the software module 906 from the memory 905, thereby performing the processing of the gNB 2 described in the example embodiments described above.

If the gNB 2 is a gNB-CU or a CU-CP, the gNB 2 does not need to include the RF transceiver 901 (and the antenna array 902).

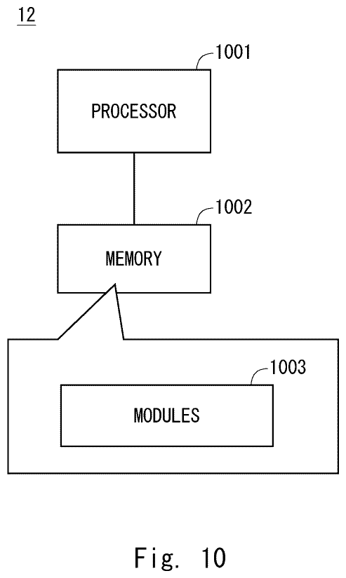

FIG. 10 is a block diagram showing an example configuration of the NCR-MT 12. Referring to FIG. 10, the NCR-MT 12 includes a processor 1001 and a memory 1002.

The processor 1001 may include a plurality of processors. The processor 1001 performs the processing related to the NCR-MT 12 described in the above example embodiments. The processor 1802 performs digital baseband signal processing (data plane processing) and control plane processing for radio communication. For example, the processor 1001 may include a modem processor (e.g., a Digital Signal Processor (DSP)) that performs digital baseband signal processing and a protocol stack processor (e.g., a Central Processing Unit (CPU) or a Micro Processing Unit (MPU)) that performs control plane processing. The digital baseband signal processing may include signal processing for the RLC, MAC, and PHY layers. The control plane processing may include processing for MAC CEs and DCIs.

The memory 1002 is composed of a combination of volatile memory and non-volatile memory. The memory 1002 may include a plurality of physically independent memory devices. The volatile memory is, for example, SRAM or DRAM or a combination thereof.

The non-volatile memory is, for example, MROM, EEPROM, flash memory, or a hard disk drive, or any combination thereof. For example, the memory 1002 may include an external memory device that is accessible by the processor 1001. The memory 1002 may include an internal memory device integrated within the processor 1001. The memory 1002 may include memory within a Universal Integrated Circuit Card (UICC).

The memory 1002 may store one or more software modules (computer programs) 1003 containing a set of instructions and data for performing the processing by the NCR-MT 12 as described in the above example embodiments. In some implementations, the processor 1001 may be configured to read and execute the software modules 1003 from the memory 1002, thereby performing the processing of the NCR-MT 12 as described in the above example embodiments.

As explained using FIGS. 9 and 10, each of the processors of the gNB 2 and NCR-MT 12 in the above example embodiments can execute one or more programs, containing a set of instructions, to cause a computer to perform an algorithm described with reference to the drawings. Each of these programs contains a set of instructions (or software codes) that, when loaded into a computer, causes the computer to perform one or more of the functions described in the example embodiments. Each of these programs may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered trademark) disc or other optical disk storage, magnetic cassettes, magnetic tape, magnetic disk storage or other magnetic storage devices. Each program may be transmitted on a transitory computer readable medium or a communication medium. By way of example, and not limitation, transitory computer readable media or communication media can include electrical, optical, acoustic, or other form of propagated signals.

The example embodiments described above are merely examples of applications of the technical ideas of the inventors. These technical ideas are not limited to the above-described example embodiments, and various modifications may be made thereto.

For example, the whole or part of the example embodiments disclosed above can be described as, but not limited to, the following supplementary notes.

### Supplementary Note 1

A Network Controlled Repeater (NCR) comprising:
a repeater unit comprising a radio frequency (RF) component and configured to amplify and forward RF signals; and
a controller coupled to the repeater unit and configured to termination (MT), wherein
the controller is configured to use an NCR-MT-specific second minimum required received power or minimum required quality level in a cell to determine whether the cell meets a cell selection criterion, and
the second minimum required received power or minimum required quality level is different from a first minimum required received power or minimum required quality level in the cell for a normal User Equipment (UE) that is not an NCR-MT.

### Supplementary Note 2

The NCR according to Supplementary Note 1, wherein the second minimum required received power or minimum required quality level is greater than the first minimum required received power or minimum required quality level.

### Supplementary Note 3

The NCR according to Supplementary Note 1 or 2, wherein
the controller is configured to receive cell selection information broadcast in the cell,
the cell selection information comprises a first parameter and a second parameter,
the first parameter represents the first minimum required received power or minimum required quality level, and
the second parameter represents the second minimum required received power or minimum required quality level.

### Supplementary Note 4

The NCR according to Supplementary Note 1 or 2, wherein
the controller is configured to receive cell selection information broadcast in the cell,
the cell selection information comprises a first parameter and a third parameter,
the first parameter represents the first minimum required received power or minimum required quality level, and
the third parameter is used by the controller to derive the second minimum required received power or minimum required quality level from the first parameter.

### Supplementary Note 5

The NCR according to Supplementary Note 1 or 2, wherein
the controller is configured to receive cell selection information broadcast in the cell,
the cell selection information comprises a first parameter,
the first parameter represents the first minimum required received power or minimum required quality level, and
the controller is configured to derive the second minimum required received power or minimum required quality level from the first parameter.

### Supplementary Note 6

The NCR according to any one of Supplementary Notes 1 to 5, wherein
the repeater unit is configured to forward the RF signals between a radio access network (RAN) node and User Equipments (UEs), and
the NCR-MT is adapted to communicate with the RAN node via a control link to exchange control information.

### Supplementary Note 7

A radio access network (RAN) node comprising:
means for broadcasting cell selection information in a cell, wherein
the cell selection information comprises a first parameter and further comprises a second parameter or a third parameter,
the first parameter represents a first minimum required received power or minimum required quality level in the cell used for cell selection by a normal User Equipment (UE) that is not a Network Controlled Repeater (NCR) mobile termination (MT),
the second parameter represents a second minimum required received power or minimum required quality level in the cell used for cell selection by the NCR-MT, and
the third parameter is used by the NCR-MT to derive the second minimum required received power or minimum required quality level from the first

### Supplementary Note 8

The RAN node according to Supplementary Note 7, wherein the second minimum required received power or minimum required quality level is greater than the first minimum required received power or minimum required quality level.

### Supplementary Note 9

The RAN node according to Supplementary Note 7 or 8, wherein the NCR-MT is a mobile termination function within an NCR that is configured to forward radio frequency (RF) signals between the RAN node and UEs.

### Supplementary Note 10

A method performed by a Network Controlled Repeater (NCR), the method comprising:
using an NCR-MT-specific second minimum required received power or minimum required quality level in a cell to determine whether the cell meets a cell selection criterion, wherein
the second minimum required received power or minimum required quality level is different from a first minimum required received power or minimum required quality level in the cell for a normal User Equipment (UE) that is not an NCR-MT.

### Supplementary Note 11

A method performed by a radio access network (RAN) node, the method comprising:
broadcasting cell selection information in a cell, wherein
the cell selection information comprises a first parameter and further comprises a second parameter or a third parameter,
the first parameter represents a first minimum required received power or minimum required quality level in the cell used for cell selection by a normal User Equipment (UE) that is not a Network Controlled Repeater (NCR) mobile termination (MT),
the second parameter represents a second minimum required received power or minimum required quality level in the cell used for cell selection by the NCR-MT, and
the third parameter is used by the NCR-MT to derive the second minimum required received power or minimum required quality level from the first parameter.

### Supplementary Note 12

A program for causing a computer to perform a method for a Network Controlled Repeater (NCR),
the method comprising using an NCR-MT-specific second minimum required received power or minimum required quality level in a cell to determine whether the cell meets a cell selection criterion, wherein
the second minimum required received power or minimum required quality level is different from a first minimum required received power or minimum required quality level in the cell for a normal User Equipment (UE) that is not an NCR-MT.

### Supplementary Note 13

A program for causing a computer to perform a method for a radio access network (RAN) node,
the method comprising broadcasting cell selection information in a cell, wherein
the cell selection information comprises a first parameter and further comprises a second parameter or a third parameter,
the first parameter represents a first minimum required received power or minimum required quality level in the cell used for cell selection by a normal User Equipment (UE) that is not a Network Controlled Repeater (NCR) mobile termination (MT),
the second parameter represents a second minimum required received power or minimum required quality level in the cell used for cell selection by the NCR-MT, and
the third parameter is used by the NCR-MT to derive the second minimum required received power or minimum required quality level from the first parameter.

### Supplementary Note 14

A Network Controlled Repeater (NCR) comprising:
a repeater unit comprising a radio frequency (RF) component and configured to amplify and forward RF signals between a radio access network (RAN) node and User Equipments (UEs); and
a controller coupled to the repeater unit and configured to communicate with the RAN node via a control link to exchange control information, wherein
the controller is configured to:
   receive a Radio Resource Control (RRC) release message from the RAN node requesting release of an RRC connection and indicating an access restriction period; and
   refrain from initiating a random access procedure to the cell until at least the access restriction period has elapsed if a received power or received quality level in the cell is lower than a threshold value.

### Supplementary Note 15

The NCR according to Supplementary Note 14, wherein the access restriction period is more than one hour.

### Supplementary Note 16

The NCR according to Supplementary Note 14 or 15, wherein the RRC release message further indicates the threshold value.

### Supplementary Note 17

The NCR according to any one of Supplementary Notes 14 to 16, wherein the RRC release message indicates that a cause for releasing the RRC connection is a decrease or insufficiency of a received power or received quality level in the cell.

### Supplementary Note 18

A radio access network (RAN) node comprising:
means for determining release of a Radio Resource Control (RRC) connection in a cell for a Network Controlled Repeater (NCR) in response to a decrease or insufficiency of a received power or received quality level in the cell; and
means for sending an RRC release message indicating an access restriction period to the NCR, wherein
the RRC release message causes the NCR to refrain from initiating a random access procedure to the cell until at least the access restriction period has elapsed if a received power or received quality level in the cell is lower than a threshold value.

### Supplementary Note 19

The RAN node according to Supplementary Note 18, wherein the access restriction period is more than one hour.

### Supplementary Note 20

The RAN node according to Supplementary Note 18 or 19, wherein the RRC release message further indicates the threshold value.

### Supplementary Note 21

The RAN node according to any one of Supplementary Notes 18 to 20, wherein the RRC release message indicates that a cause for releasing the RRC connection is a decrease or insufficiency of a received power or received quality level in the cell.

### Supplementary Note 22

A method performed by a Network Controlled Repeater (NCR), the method comprising:
receiving a Radio Resource Control (RRC) release message from a radio access network (RAN) node requesting release of an RRC connection and indicating an access restriction period; and
refraining from initiating a random access procedure to the cell until at least the access restriction period has elapsed if a received power or received quality level in the cell is lower than a threshold value.

### Supplementary Note 23

A method performed by a radio access network (RAN) node, the method comprising:
determining release of a Radio Resource Control (RRC) connection in a cell for a Network Controlled Repeater (NCR) in response to a decrease or insufficiency of a received power or received quality level in the cell; and
sending an RRC release message indicating an access restriction period to the NCR, wherein
the RRC release message causes the NCR to refrain from initiating a random access procedure to the cell until at least the access restriction period has elapsed if a received power or received quality level in the cell is lower than a threshold value.

### Supplementary Note 24

A program for causing a computer to perform a method for a Network Controlled Repeater (NCR), the method comprising:
receiving a Radio Resource Control (RRC) release message from a radio access network (RAN) node requesting release of an RRC connection and indicating an access restriction period; and
refraining from initiating a random access procedure to the cell until at least the access restriction period has elapsed if a received power or received quality level in the cell is lower than a threshold value.

### Supplementary Note 25

A program for causing a computer to perform a method for a radio access network (RAN) node, the method comprising:
determining release of a Radio Resource Control (RRC) connection in a cell for a Network Controlled Repeater (NCR) in response to a decrease or insufficiency of a received power or received quality level in the cell; and
sending an RRC release message indicating an access restriction period to the NCR, wherein
the RRC release message causes the NCR to refrain from initiating a random access procedure to the cell until at least the access restriction period has elapsed if a received power or received quality level in the cell is lower than a threshold value.

### Supplementary Note 26

A Network Controlled Repeater (NCR) comprising:
a repeater unit comprising a radio frequency (RF) component and configured to amplify and forward RF signals between a radio access network (RAN) node and User Equipments (UEs); and
a controller coupled to the repeater unit and configured to communicate with the RAN node via a control link to exchange control information, wherein
the controller is configured to transmit a Radio Resource Control (RRC) setup or resume request message requesting an establishment or resumption of an RRC connection in a cell, and
the RRC setup or resume request message indicates a measurement result for the cell recorded while the NCR is RRC_IDLE or RRC_INACTIVE.

### Supplementary Note 27

The NCR according to Supplementary Note 26, wherein the controller is configured to:
after transmitting the RRC setup or resume request message, receive an RRC reject message indicating a rejection of the establishment or resumption of the RRC connection and indicating an access restriction period; and
refrain from initiating a random access procedure to the cell until at least the access restriction period has elapsed if a received power or received quality level in the cell is lower than a threshold value.

### Supplementary Note 28

The NCR according to Supplementary Note 27, wherein the access restriction period is more than one hour.

### Supplementary Note 29

The NCR according to Supplementary Note 27 or 28, wherein the RRC reject message further indicates the threshold value.

### Supplementary Note 30

The NCR according to any one of Supplementary Notes 27 to 29, wherein the RRC reject message indicates that a cause for the rejection of the establishment or resumption of the RRC connection is an insufficient received power or received quality level in the cell.

### Supplementary Note 31

A radio access network (RAN) node comprising:
means for receiving from a Network Controlled Repeater (NCR) a Radio Resource Control (RRC) setup or resume request message requesting an establishment or resumption of an RRC connection in a cell, wherein
the RRC setup or resume request message indicates a measurement result for the cell recorded while the NCR is RRC_IDLE or RRC_INACTIVE.

### Supplementary Note 32

The RAN node according to Supplementary Note 31, further comprising means for, in response to determining that a received power or received quality level of the NCR in the cell is insufficient based on the measurement result for the cell, sending to the NCR an RRC reject message indicating a rejection of the establishment or resumption of the RRC connection and indicating an access restriction period, wherein
the RRC reject message causes the NCR to refrain from initiating a random access procedure to the cell until at least the access restriction period has elapsed if a received power or received quality level in the cell is lower than a threshold value.

### Supplementary Note 33

The RAN node according to Supplementary Note 32, wherein the access restriction period is more than one hour.

### Supplementary Note 34

The RAN node according to Supplementary Note 32 or 33, wherein the RRC reject message further indicates the threshold value.

### Supplementary Note 35

The RAN node according to any one of Supplementary Notes 32 to 34, wherein the RRC reject message indicates that a cause for the rejection of the establishment or resumption of the RRC connection is an insufficient received power or received quality level in the cell.

### Supplementary Note 36

A method performed by a Network Controlled Repeater (NCR), the method comprising:
transmitting a Radio Resource Control (RRC) setup or resume request message requesting an establishment or resumption of an RRC connection in a cell, wherein
the RRC setup or resume request message indicates a measurement result for the cell recorded while the NCR is RRC_IDLE or RRC_INACTIVE.

### Supplementary Note 37

A method performed by a radio access network (RAN) node, the method comprising:
receiving from a Network Controlled Repeater (NCR) a Radio Resource Control (RRC) setup or resume request message requesting an establishment or resumption of an RRC connection in a cell, wherein
the RRC setup or resume request message indicates a measurement result for the cell recorded while the NCR is RRC_IDLE or RRC_INACTIVE.

### Supplementary Note 38

A program for causing a computer to perform a method for a Network Controlled Repeater (NCR),
the method comprising transmitting a Radio Resource Control (RRC) setup or resume request message requesting an establishment or resumption of an RRC connection in a cell, wherein
the RRC setup or resume request message indicates a measurement result for the cell recorded while the NCR is RRC_IDLE or RRC_INACTIVE.

### Supplementary Note 39

A program for causing a computer to perform a method for a radio access network (RAN) node,
the method comprising receiving from a Network Controlled Repeater (NCR) a Radio Resource Control (RRC) setup or resume request message requesting an establishment or resumption of an RRC connection in a cell, wherein
the RRC setup or resume request message indicates a measurement result for the cell recorded while the NCR is RRC_IDLE or RRC_INACTIVE.

### Supplementary Note 40

A Network Controlled Repeater (NCR) comprising:
a repeater unit comprising a radio frequency (RF) component and configured to amplify and forward RF signals between a radio access network (RAN) node and User Equipments (UEs); and
a controller coupled to the repeater unit and configured to communicate with the RAN node via a control link to exchange control information, wherein
the controller is configured to transmit a Radio Resource Control (RRC) setup or resume complete message indicating completion of establishment or resumption of an RRC connection in a cell, and
the RRC setup or resume complete message indicates a measurement result for the cell recorded while the NCR is RRC_IDLE or RRC_INACTIVE.

### Supplementary Note 41

The NCR according to Supplementary Note 40, wherein the controller is configured to:
after transmitting the RRC setup or resume complete message, receive an RRC release message indicating release of the RRC connection and indicating an access restriction period; and
refrain from initiating a random access procedure to the cell until at least the access restriction period has elapsed if a received power or received quality level in the cell is lower than a threshold value.

### Supplementary Note 42

The NCR according to Supplementary Note 41, wherein the access restriction period is more than one hour.

### Supplementary Note 43

The NCR according to Supplementary Note 41 or 42, wherein the RRC release message further indicates the threshold value.

### Supplementary Note 44

The NCR according to any one of Supplementary Notes 41 to 43, wherein the RRC release message indicates that a cause for the release of the RRC connection is an insufficient received power or received quality level in the cell.

### Supplementary Note 45

A radio access network (RAN) node comprising:
means for receiving from a Network Controlled Repeater (NCR) a Radio Resource Control (RRC) setup or resume complete message indicating completion of establishment or resumption of an RRC connection in a cell, wherein
the RRC setup or resume complete message indicates a measurement result for the cell recorded while the NCR is RRC_IDLE or RRC_INACTIVE.

### Supplementary Note 46

The RAN node according to Supplementary Note 45, further comprising means for, in response to determining that a received power or received quality level of the NCR in the cell is insufficient based on the measurement result for the cell, sending to the NCR an RRC release message indicating release of the RRC connection and indicating an access restriction period, wherein
the RRC release message causes the NCR to refrain from initiating a random access procedure to the cell until at least the access restriction period has elapsed if a received power or received quality level in the cell is lower than a threshold value.

### Supplementary Note 47

The RAN node according to Supplementary Note 46, wherein the access restriction period is more than one hour.

### Supplementary Note 48

The RAN node according to Supplementary Note 46 or 47, wherein the RRC release message further indicates the threshold value.

### Supplementary Note 49

The RAN node according to any one of Supplementary Notes 46 to 48, wherein the RRC release message indicates that a cause for the release of the RRC connection is an insufficient received power or received quality level in the cell.

### Supplementary Note 50

A method performed by a Network Controlled Repeater (NCR), the method comprising:
transmitting a Radio Resource Control (RRC) setup or resume complete message indicating completion of establishment or resumption of an RRC connection in a cell, wherein
the RRC setup or resume complete message indicates a measurement result for the cell recorded while the NCR is RRC_IDLE or RRC_INACTIVE.

### Supplementary Note 51

A method performed by a radio access network (RAN) node, the method comprising:
receiving from a Network Controlled Repeater (NCR) a Radio Resource Control (RRC) setup or resume complete message indicating completion of establishment or resumption of an RRC connection in a cell, wherein
the RRC setup or resume complete message indicates a measurement result for the cell recorded while the NCR is RRC_IDLE or RRC_INACTIVE.

### Supplementary Note 52

A program for causing a computer to perform a method for a Network Controlled Repeater (NCR),
the method comprising transmitting a Radio Resource Control (RRC) setup or resume complete message indicating completion of establishment or resumption of an RRC connection in a cell, wherein
the RRC setup or resume complete message indicates a measurement result for the cell recorded while the NCR is RRC_IDLE or RRC_INACTIVE.

### Supplementary Note 53

A program for causing a computer to perform a method for a radio access network (RAN) node,
the method comprising receiving from a Network Controlled Repeater (NCR) a Radio Resource Control (RRC) setup or resume complete message indicating completion of establishment or resumption of an RRC connection in a cell, wherein
the RRC setup or resume complete message indicates a measurement result for the cell recorded while the NCR is RRC_IDLE or RRC_INACTIVE.

This application is based upon and claims the benefit of priority from Japanese Patent Application No. 2022-155435, filed on Sep. 28, 2022, the disclosure of which is incorporated herein in its entirety by reference.

### REFERENCE SIGNS LIST

1 NCR
2 gNB
3 UE
11 NCR-Fwd
12 NCR-MT
904 Processor
905 Memory
906 Modules
1001 Processor
1002 Memory
1003 Modules

What is claimed is:

1.-9. (canceled)

10. A method performed by a Network Controlled Repeater (NCR), the method comprising:
using an NCR-MT-specific second minimum required received power or minimum required quality level in a cell to determine whether the cell meets a cell selection criterion, wherein
the second minimum required received power or minimum required quality level is different from a first minimum required received power or minimum required quality level in the cell for a normal User Equipment (UE) that is not an NCR-MT.

11. A method performed by a radio access network (RAN) node, the method comprising:
broadcasting cell selection information in a cell, wherein
the cell selection information comprises a first parameter and further comprises a second parameter or a third parameter,
the first parameter represents a first minimum required received power or minimum required quality level in the cell used for cell selection by a normal User Equipment (UE) that is not a Network Controlled Repeater (NCR) mobile termination (MT),
the second parameter represents a second minimum required received power or minimum required quality level in the cell used for cell selection by the NCR-MT, and
the third parameter is used by the NCR-MT to derive the second minimum required received power or minimum required quality level from the first parameter.

12.-21. (canceled)

22. A method performed by a Network Controlled Repeater (NCR), the method comprising:
receiving a Radio Resource Control (RRC) release message from a radio access network (RAN) node requesting release of an RRC connection and indicating an access restriction period; and
refraining from initiating a random access procedure to the cell until at least the access restriction period has elapsed if a received power or received quality level in the cell is lower than a threshold value.

23. A method performed by a radio access network (RAN) node, the method comprising:
determining release of a Radio Resource Control (RRC) connection in a cell for a Network Controlled Repeater (NCR) in response to a decrease or insufficiency of a received power or received quality level in the cell; and
sending an RRC release message indicating an access restriction period to the NCR, wherein
the RRC release message causes the NCR to refrain from initiating a random access procedure to the cell until at least the access restriction period has elapsed if a received power or received quality level in the cell is lower than a threshold value.

24.-35. (canceled)

36. A method performed by a Network Controlled Repeater (NCR), the method comprising:
transmitting a Radio Resource Control (RRC) setup or resume request message requesting an establishment or resumption of an RRC connection in a cell, wherein
the RRC setup or resume request message indicates a measurement result for the cell recorded while the NCR is RRC_IDLE or RRC_INACTIVE.

37. A method performed by a radio access network (RAN) node, the method comprising:
receiving from a Network Controlled Repeater (NCR) a Radio Resource Control (RRC) setup or resume request message requesting an establishment or resumption of an RRC connection in a cell, wherein
the RRC setup or resume request message indicates a measurement result for the cell recorded while the NCR is RRC_IDLE or RRC_INACTIVE.

38.-49. (canceled)

50. A method performed by a Network Controlled Repeater (NCR), the method comprising:
transmitting a Radio Resource Control (RRC) setup or resume complete message indicating completion of establishment or resumption of an RRC connection in a cell, wherein
the RRC setup or resume complete message indicates a measurement result for the cell recorded while the NCR is RRC_IDLE or RRC_INACTIVE.

51. A method performed by a radio access network (RAN) node, the method comprising:
receiving from a Network Controlled Repeater (NCR) a Radio Resource Control (RRC) setup or resume complete message indicating completion of establishment or resumption of an RRC connection in a cell, wherein
the RRC setup or resume complete message indicates a measurement result for the cell recorded while the NCR is RRC_IDLE or RRC_INACTIVE.

52.-53 (canceled)

54. The method according to claim 10, wherein the second minimum required received power or minimum required quality level is greater than the first minimum required received power or minimum required quality level.

55. The method according to claim 10, further comprising receiving cell selection information broadcast in the cell, wherein
the cell selection information comprises a first parameter and a second parameter,
the first parameter represents the first minimum required received power or minimum required quality level, and
the second parameter represents the second minimum required received power or minimum required quality level.

56. The method according to claim 10, further comprising receiving cell selection information broadcast in the cell, wherein
the cell selection information comprises a first parameter and a third parameter,
the first parameter represents the first minimum required received power or minimum required quality level, and
the third parameter is used by the NCR to derive the second minimum required received power or minimum required quality level from the first parameter.

57. The method according to claim 10, further comprising receiving cell selection information broadcast in the cell, wherein
the cell selection information comprises a first parameter,
the first parameter represents the first minimum required received power or minimum required quality level, and
the method further comprises deriving the second minimum required received power or minimum required quality level from the first parameter.

58. The method according to claim 10, wherein the NCR comprises:
a repeater unit is configured to forward radio frequency (RF) signals between a radio access network (RAN) node and User Equipments (UEs); and
an NCR mobile termination (MT) configured to communicate with the RAN node via a control link to exchange control information.

59. The method according to claim 11, wherein the second minimum required received power or minimum required quality level is greater than the first minimum required received power or minimum required quality level.

60. The method according to claim 11, wherein the NCR-MT is a mobile termination function within an NCR that is configured to forward radio frequency (RF) signals between the RAN node and UEs.

61. The method according to claim 36, further comprising:
after transmitting the RRC setup or resume request message, receiving an RRC reject message indicating a rejection of the establishment or resumption of the RRC connection and indicating an access restriction period; and
refraining from initiating a random access procedure to the cell until at least the access restriction period has elapsed if a received power or received quality level in the cell is lower than a threshold value.

62. The method according to claim 37, further comprising, in response to determining that a received power or received quality level of the NCR in the cell is insufficient based on the measurement result for the cell, sending to the NCR an RRC reject message indicating a rejection of the establishment or resumption of the RRC connection and indicating an access restriction period, wherein
the RRC reject message causes the NCR to refrain from initiating a random access procedure to the cell until at least the access restriction period has elapsed if a received power or received quality level in the cell is lower than a threshold value.

63. The method according to claim 50, further comprising:
after transmitting the RRC setup or resume complete message, receiving an RRC release message indicating release of the RRC connection and indicating an access restriction period; and
refraining from initiating a random access procedure to the cell until at least the access restriction period has elapsed if a received power or received quality level in the cell is lower than a threshold value.

64. The method according to claim 51, further comprising, in response to determining that a received power or received quality level of the NCR in the cell is insufficient based on the measurement result for the cell, sending to the NCR an RRC release message indicating release of the RRC connection and indicating an access restriction period, wherein
the RRC release message causes the NCR to refrain from initiating a random access procedure to the cell until at least the access restriction period has elapsed if a received power or received quality level in the cell is lower than a threshold value.
